(19) United States
(12) Patent Application Publication
(10) Pub. No.: US 2022/0025830 A1
(43) Pub. Date: Jan. 27, 2022

(54) COOLING SYSTEM FOR CYLINDER HEAD AND COOLING SYSTEM FOR VEHICLE PROVIDED WITH THE SAME

(71) Applicants: Hyundai Motor Company, Seoul (KR); Kia Motors Corporation, Seoul (KR)

(72) Inventors: Junghoon PARK, Anyang-Si (KR); WonGi Lee, Hwaseong-Si (KR); Kyounghee Kim, Ansan-Si (KR); Tae Won Lee, Incheon (KR)

(73) Assignees: Hyundai Motor Company, Seoul (KR); Kia Motors Corporation, Seoul (KR)

(21) Appl. No.: 17/106,872

(22) Filed: Nov. 30, 2020

(51) Int. Cl. F02F 1/40; F01P 3/02; F02M 26/41

(52) U.S. Cl. CPC F02F 1/40; F01P 2003/024; F02M 26/41; F01P 3/02

(57) ABSTRACT

A cylinder head cooling system may include a main water jacket formed on a cylinder head, an exhaust port formed on the cylinder head, and an exhaust port water jacket formed to cool the exhaust port, wherein, the exhaust port water jacket includes an inlet that communicates with the main water jacket and a plurality of outlets separated from the main water jacket.

### CROSS-REFERENCE TO RELATED APPLICATION

The present application claims priority to Korean Patent Application No. 10-2020-0091676 filed on Jul. 23, 2020, the entire contents of which is incorporated herein for all purposes by this reference.

### BACKGROUND OF THE INVENTION

### Field of the Invention

The present invention relates to a cylinder head cooling system and a vehicle cooling system provided with the same. More particularly, the present invention relates to a cooling system of a cylinder head of which an integral exhaust manifold and a cooling system for a vehicle provided with the same.

### Description of Related Art

In general, some of heat generated in an engine's combustion chamber is absorbed by a cylinder head, a cylinder block, an exhaust valve, a piston and the like.

When the temperature of these components rises excessively, thermal deformation occurs or the oil film on the internal wall of the cylinder is destroyed, resulting in defective lubrication, and thus resulting in thermal failure.

The thermal failure of the engine described above can cause serious damage such as melting of the piston by generating abnormal combust such as poor combust and knocking. Furthermore, there is a problem that heat efficiency and output are deteriorated. On the other hand, excessive cooling of the engine has problems such as deterioration of output and fuel efficiency and low temperature wear of the cylinder, so it is necessary to properly control the coolant temperature.

In the present respect, in the engine according to the conventional art, a water jacket is formed inside the cylinder block and the cylinder head, and the coolant circulating through the water jacket cools the metal surface around the spark plug corresponding to the combustion chamber, the exhaust port, and the valve seat.

Recently, a method using a three-way catalyst converter and a method of downsizing the engine by applying a turbocharger are applied as technologies to cope with the reinforced exhaust gas regulation.

However, high temperature exhaust gas can cause damage to the three-way catalyst and damage the turbine wheel of the turbocharger.

There is a method of applying a cylinder head with an integral exhaust manifold as a technology that controls the temperature of the exhaust gas at high temperatures to prevent damage to the three-way catalyst or turbine wheel.

The information included in this Background of the present invention section is only for enhancement of understanding of the general background of the present invention and may not be taken as an acknowledgement or any form of suggestion that this information forms the prior art already known to a person skilled in the art.

### BRIEF SUMMARY

Various aspects of the present invention are directed to providing a cylinder head cooling system configured for effectively cooling a cylinder head having an integral exhaust manifold formed therein, and a vehicle cooling system provided with the same.

A cylinder head cooling system according to various exemplary embodiments of the present invention may include a main water jacket formed on a cylinder head, an exhaust port formed on the cylinder head, and an exhaust port water jacket formed to cool the exhaust port, wherein, the exhaust port water jacket includes an inlet that communicates with the main water jacket and a plurality of outlets separated from the main water jacket.

The plurality of outlets may include an upper outlet where the coolant inflowed through the inlet is exhausted, and a lower outlet formed below the upper outlet so that the coolant inflowed through the inlet is exhausted from the lower outlet.

The exhaust port water jacket may include an upper passage formed in a longitudinal direction of the cylinder head, and a lower passage formed under the upper passage in the longitudinal direction of the cylinder head.

The exhaust port water jacket may further include a plurality of connecting passages connecting the upper passage and the lower passage.

At least a portion of the exhaust port may be formed between a space formed by the upper passage, the lower passage and the plurality of connecting passages.

The cylinder head cooling system may further include an inclined portion formed at a connecting passage adjacent to the exhaust port among the plurality of connecting passages.

The cylinder head cooling system may further include a protrusion formed protrude to cool the exhaust port.

The inlet and the lower outlet may be formed in the lower passage.

The upper outlet may be formed at the upper passage.

A vehicle cooling system according to various exemplary embodiments of the present invention may have an engine including a cylinder block and a cylinder head, a radiator cooling a coolant, a reservoir tank, and an exhaust gas recirculation (EGR) cooler cooling EGR gas. The vehicle cooling system may include a main water jacket formed on the cylinder head and supplied with the coolant from the cylinder block, an exhaust port formed on the cylinder head, and an exhaust port water jacket formed to cool the exhaust port, wherein the exhaust port water jacket may include an inlet that communicates with the main water jacket, an upper outlet that communicates with the reservoir tank, and a lower outlet which is separated from the main water jacket and communicates with the EGR cooler.

The exhaust port water jacket may include an upper passage formed in a longitudinal direction of the cylinder head, and a lower passage formed under the upper passage in the longitudinal direction of the cylinder head.

The exhaust port water jacket may further include a plurality of connecting passages connecting the upper passage and the lower passage.

At least a portion of the exhaust port may be formed between a space formed by the upper passage, the lower passage and the plurality of connecting passages.

The vehicle cooling system may further include an inclined portion formed at a connecting passage adjacent to the exhaust port among the plurality of connecting passages.

The exhaust port water jacket may further include a protrusion formed protrude to cool the exhaust port.

The inlet and the lower outlet may be formed in the lower passage.

The upper outlet may be formed at the upper passage.

According to the cylinder head cooling system according to various exemplary embodiments of the present invention and the vehicle cooling system provided with the same, it is possible to effectively cool a cylinder head having an integral exhaust manifold.

According to various exemplary embodiments of the present invention, the cylinder head cooling system and the vehicle cooling system including the same can secure a flow rate of a coolant for cooling the exhaust port, properly lowering the exhaust gas temperature.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic diagram of a cooling system for a vehicle according to various exemplary embodiments of the present invention.

FIG. 2 is a perspective view of a cylinder head cooling system according to various exemplary embodiments of the present invention.

FIG. 3 is a front view of an exhaust port water jacket of a cylinder head cooling system according to various exemplary embodiments of the present invention.

FIG. 4 is a drawing showing an outlet of the exhaust port water jacket of the cylinder head cooling system according to various exemplary embodiments of the present invention.

FIG. 5 is a perspective view of a cylinder head cooling system according to various exemplary embodiments of the present invention including an exhaust manifold.

FIG. 6 is a perspective view of an exhaust port water jacket of the cylinder head cooling system according to various exemplary embodiments of the present invention.

FIG. 7 is a drawing showing coolant flow of the main water jacket of the cylinder head cooling system according to various exemplary embodiments of the present invention.

FIG. 8 is a drawing showing the coolant flow of an exhaust port water jacket of the cylinder head cooling system according to various exemplary embodiments of the present invention.

FIG. 9 is a drawing showing the flow rate of coolant flowing through the cylinder head cooling system according to various exemplary embodiments of the present invention.

It may be understood that the appended drawings are not necessarily to scale, presenting a somewhat simplified representation of various features illustrative of the basic principles of the present invention. The specific design features of the present invention as included herein, including, for example, specific dimensions, orientations, locations, and shapes will be determined in part by the particularly intended application and use environment.

In the figures, reference numbers refer to the same or equivalent portions of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

In the following detailed description, only certain exemplary embodiments of the present invention have been shown and described, simply by way of illustration.

As those skilled in the art would realize, the described embodiments may be modified in various different ways, all without departing from the spirit or scope of the present invention

Parts marked with the same reference number throughout the specification mean the same constituent elements.

In the drawings, the thickness of layers, films, panels, regions, etc., are exaggerated for clarity.

When a part such as a layer, film, region, or plate is said to be “on” another part, the present includes not only the case directly above the other part, but also the case where there is another part in between.

In contrast, when an element is referred to as being “directly on” another element, there are no intervening elements present.

Throughout the specification, unless explicitly described to the contrary, the word “comprise”, and variations such as “comprises” or “comprising”, will be understood to imply the inclusion of stated elements but not the exclusion of any other elements.

Various exemplary embodiments of the present invention will hereinafter be described in detail with reference to the accompanying drawings.

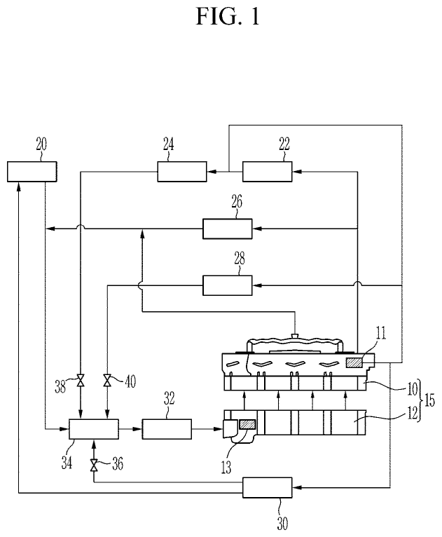

FIG. 1 is a schematic diagram of a cooling system for a vehicle according to various exemplary embodiments of the present invention.

Referring to FIG. 1, an exemplary embodiment of the cylinder head cooling system according to various exemplary embodiments of the present invention includes an engine 15 including a cylinder block 12 and a cylinder head 10, a radiator 30 for cooling a coolant, a reservoir tank 20, and an exhaust gas recirculation (EGR) cooler 22 for cooling EGR gas.

Furthermore, the cylinder head cooling system according to various exemplary embodiments of the present invention may include a water pump 32, a heater 24, and an oil cooler 28 supplying the coolant to the engine 15, and a flow control valve 34 including valves 36, 38, and 40 that control the coolant flow in each coolant passage. Also, some of the coolant may be supplied to cool the turbocharger 26.

The coolant that has passed the water pump 32 is supplied to the cylinder block 13 through a cylinder block inlet 13 and is exhausted through a cylinder head outlet 11 of the cylinder head 10.

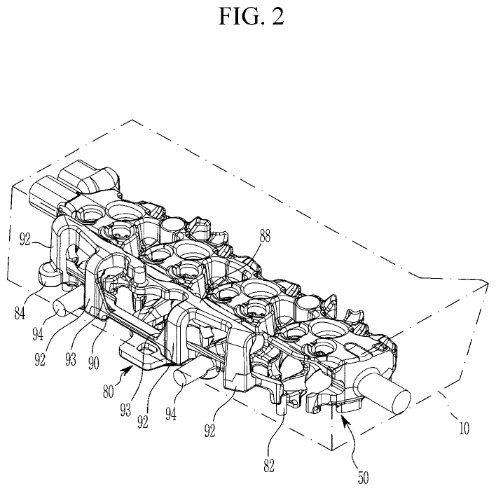

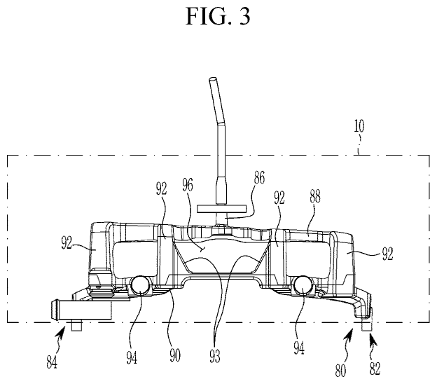

FIG. 2 is a perspective view of a cylinder head cooling system according to various exemplary embodiments of the present invention, and FIG. 3 is a front view of an exhaust port water jacket of a cylinder head cooling system according to various exemplary embodiments of the present invention.

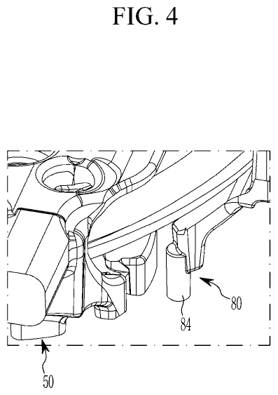

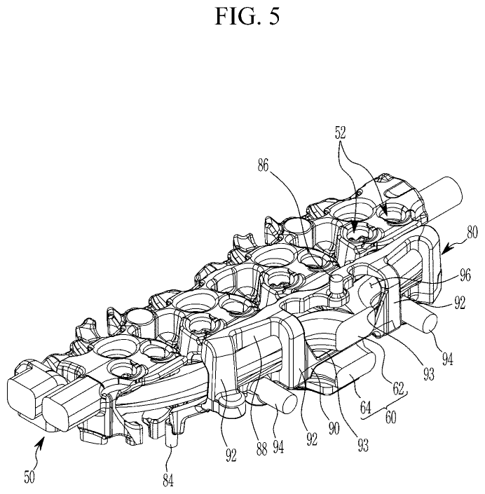

FIG. 4 is a drawing showing an outlet of the exhaust port water jacket of the cylinder head cooling system according to various exemplary embodiments of the present invention, and FIG. 5 is a perspective view of a cylinder head cooling system according to various exemplary embodiments of the present invention including an exhaust manifold.

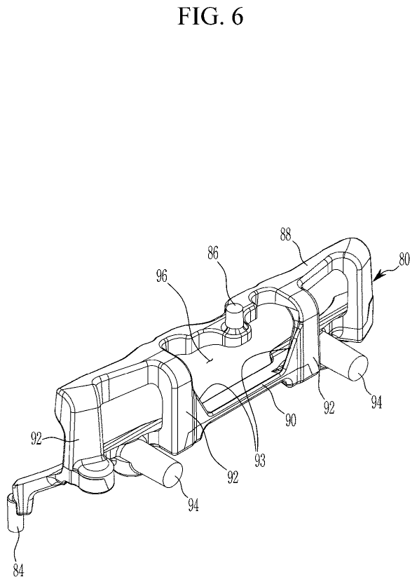

FIG. 6 is a perspective view of an exhaust port water jacket of the cylinder head cooling system according to various exemplary embodiments of the present invention.

Referring to FIG. 1 to FIG. 6, the cylinder head cooling system according to various exemplary embodiments of the present invention may include a main water jacket 50 formed on the cylinder head 10, exhaust ports 62 and 64 formed on the cylinder head 10, and an exhaust port water jacket 80 formed to cool the exhaust ports 62 and 64.

In the exhaust port water jacket 80, an inlet 82 that communicates with the main water jacket 50 may be formed, and a plurality of outlets separated from the main water jacket 50 may be formed.

The plurality of outlets may include an upper outlet 86 through which the coolant inflowed through the inlet 82 is exhausted and a lower outlet 84 formed below the upper outlet 86 so that the coolant inflowed through the inlet 82 is exhausted.

As shown in FIG. 4, the coolant that has passed the exhaust port water jacket 80 is exhausted through the lower outlet 84, and the lower outlet 84 is formed separately from the main water jacket 50, so that the coolant exhaust is not affected by the coolant flow in the main water jacket 50. In other words, it is possible to secure the flow rate of the coolant in the exhaust port water jacket 80.

The exhausted coolant from the lower outlet 84 may be delivered to the EGR cooler 22.

The cylinder head cooling system according to various exemplary embodiments of the present invention can shorten the warm-up time of the coolant by separately forming the exhaust port water jacket 80 for cooling the exhaust ports 62 and 64. In addition, the coolant that has passed the exhaust port water jacket 80 is delivered to the EGR cooler 22 to prevent condensation in the EGR cooler 22.

The cylinder head cooling system according to various exemplary embodiments of the present invention is for effectively cooling the cylinder head 10 in which the integrated exhaust manifold is formed, and the exhaust port water jacket 80 for cooling the exhaust ports of the integrated exhaust manifold 60 (62, 64; FIG. 5) is formed separately from the main water jacket 50.

The main water jacket 50 may have a configuration 52 for cooling the exhaust valve seat.

The exhaust port water jacket 40 has an upper outlet 86 to remove air from the coolant. That is, the upper outlet 86 can serve as an air vent hole for exhausting air with a coolant, and the upper outlet 86 can communicate with the reservoir tank 20.

The exhaust port water jacket 80 may include an upper passage 88 formed in the longitudinal direction of the cylinder head 10 and a lower passage 90 formed under the upper passage 88 in the longitudinal direction of the cylinder head 10. The upper outlet 86 is formed at the upper passage 88, so air in the coolant may be effectively removed.

The exhaust port water jacket 80 may further include a plurality of connecting passage 92 connecting the upper passage 88 and the lower passage 90.

At least a portion of the exhaust port 62 and 64 is formed between a space 96 formed by the upper passage 88, the lower passage 90 and the connecting passage 92.

That is, as shown in FIG. 5 and FIG. 6, one exhaust port, for example, the exhaust port 62 connected to the left and right cylinders of the drawing is formed between the space 96, and the upper passage 88, the lower passage 90 and the connecting passage 92 surround the exhaust port 62 and allow cooling. Therefore, effective cooling of exhaust gas is possible.

The exhaust port water jacket 80 may further include a protrusion 94 formed protrude to cool the exhaust port 62, and 64. That is, the protrusion 94 is formed along the direction of formation of the exhaust port 62, and 64, and effective cooling of exhaust gas is possible.

An inclined portion 93 may be formed at the connecting passage 92 adjacent to the exhaust ports 62 and 64.

The inclined portion 93 can cool the exhaust ports 62 and 64 adjacent to the exhaust ports 62 and 64, and the configured position of the inclined portion 93 can cool the hottest portion of the exhaust flange. By the inclined shape of the inclined portion 93, the resistance to the flow of the coolant in the corresponding portion may be reduced, and thus, a sufficient coolant flow rate may be secured.

Furthermore, since the shape of the water jacket is in the inclined shape the shape of the inclined portion 93 prevents the water jacket from being damaged by the pressure of the molten metal during casting.

The inlet 82 and the lower outlet 84 may be formed at the lower passage 90, through which the coolant can flow uniformly through the exhaust port water jacket 80. In other words, a uniform flow is possible without local congestion of the coolant.

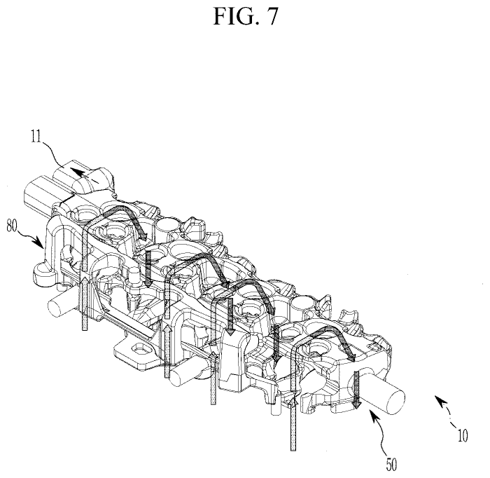

FIG. 7 is a drawing showing coolant flow of the main water jacket of the cylinder head cooling system according to various exemplary embodiments of the present invention.

Referring to FIG. 1 and FIG. 7, when the coolant supplied from the cylinder block 12 is supplied to the main water jacket 50, the coolant flows from the exhaust side of the cylinder head 10 to the intake side of the cylinder head 10, and may be exhausted through the cylinder head outlet 11.

That is, the coolant circulates from the relatively high temperature exhaust side to the intake side of the main water jacket 50, and can effectively cool the cylinder head 10.

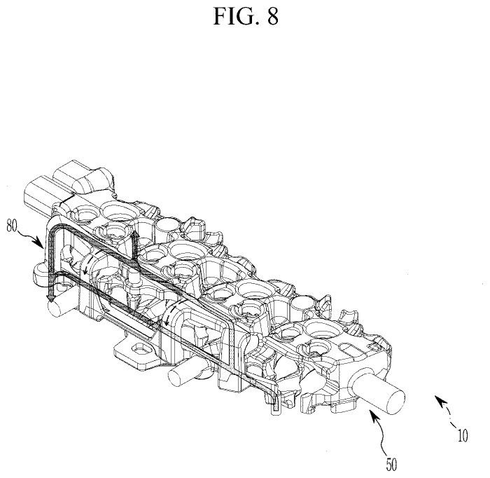

FIG. 8 is a drawing showing the coolant flow of an exhaust port water jacket of the cylinder head cooling system according to various exemplary embodiments of the present invention.

Referring to FIG. 1 and FIG. 8, the coolant that flows into the inlet 82 formed at the lower passage 90 flows to the upper passage 88 and the lower passage 90, and part of it is exhausted through the connecting passage 92 and the lower outlet 84 formed at the lower passage 90. Therefore, the coolant flow in the exhaust port water jacket 80 proceeds independently from the coolant flow in the main water jacket 50, facilitating effective coolant control.

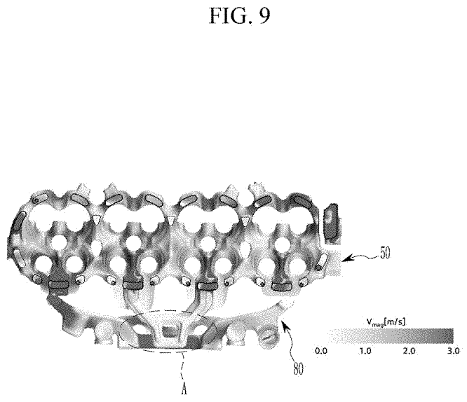

FIG. 9 is a drawing showing the flow rate of coolant flowing through the cylinder head cooling system according to various exemplary embodiments of the present invention.

FIG. 9 shows the coolant flow seen from the lower direction of the cylinder head 10.

Part (A) shown in FIG. 9 shows the coolant flow between exhaust ports of the cylinder head cooling system according to various exemplary embodiments of the present invention, and effective cooling of exhaust gas is possible by securing an appropriate flow rate of the coolant between exhaust ports.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “inner”, “outer”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. A cylinder head cooling system comprising:
a main water jacket formed on a cylinder head;
an exhaust port formed on the cylinder head; and
an exhaust port water jacket formed to cool the exhaust port,
wherein, the exhaust port water jacket includes an inlet that fluidically-communicates with the main water jacket and a plurality of outlets separated from the main water jacket.

2. The cylinder head cooling system of claim 1, wherein the plurality of outlets includes:
an upper outlet from which a coolant inflowed through the inlet is exhausted; and
a lower outlet formed below the upper outlet so that the coolant inflowed through the inlet is exhausted from the lower outlet.

3. The cylinder head cooling system of claim 2, wherein the exhaust port water jacket includes:
an upper passage formed in a longitudinal direction of the cylinder head; and
a lower passage formed under the upper passage in the longitudinal direction of the cylinder head.

4. The cylinder head cooling system of claim 3, wherein the exhaust port water jacket further includes a plurality of connecting passages connecting the upper passage and the lower passage.

5. The cylinder head cooling system of claim 4, wherein at least a portion of the exhaust port is formed between a space formed by the upper passage, the lower passage and the plurality of connecting passages.

6. The cylinder head cooling system of claim 5, further including an inclined portion formed at a connecting passage adjacent to the exhaust port among the plurality of connecting passages.

7. The cylinder head cooling system of claim 4,
wherein the exhaust port water jacket further includes a protrusion formed protrude to cool the exhaust port, and
wherein the protrusion is provided between at least two among the plurality of connecting passages.

8. The cylinder head cooling system of claim 1, wherein the exhaust port water jacket further includes a protrusion formed protrude to cool the exhaust port.

9. The cylinder head cooling system of claim 3, wherein the inlet and the lower outlet are formed in the lower passage.

10. The cylinder head cooling system of claim 3, wherein the upper outlet is formed at the upper passage.

11. A vehicle cooling system having an engine including a cylinder block and a cylinder head, a radiator cooling a coolant, a reservoir tank, and an exhaust gas recirculation (EGR) cooler cooling EGR gas, the vehicle cooling system including:
a main water jacket formed on the cylinder head and supplied with the coolant from the cylinder block;
an exhaust port formed on the cylinder head; and
an exhaust port water jacket formed to cool the exhaust port,
wherein the exhaust port water jacket includes an inlet that fluidically-communicates with the main water jacket, an upper outlet that fluidically-communicates with the reservoir tank, and a lower outlet which is separated from the main water jacket and fluidically-communicates with the EGR cooler.

12. The vehicle cooling system of claim 11, wherein the exhaust port water jacket includes:
an upper passage formed in a longitudinal direction of the cylinder head; and
a lower passage formed under the upper passage in the longitudinal direction of the cylinder head.

13. The vehicle cooling system of claim 12, wherein the exhaust port water jacket further includes a plurality of connecting passages connecting the upper passage and the lower passage.

14. The vehicle cooling system of claim 13, wherein at least a portion of the exhaust port is formed between a space formed by the upper passage, the lower passage and the plurality of connecting passages.

15. The vehicle cooling system of claim 14, further including an inclined portion formed at a connecting passage adjacent to the exhaust port among the plurality of connecting passages.

16. The cylinder head cooling system of claim 13,
wherein the exhaust port water jacket further includes a protrusion formed protrude to cool the exhaust port, and
wherein the protrusion is provided between at least two among the plurality of connecting passages.

17. The vehicle cooling system of claim 11, wherein the exhaust port water jacket further includes a protrusion formed protrude to cool the exhaust port.

18. The vehicle cooling system of claim 12, wherein the inlet and the lower outlet are formed in the lower passage.

19. The vehicle cooling system of claim 12, wherein the upper outlet is formed at the upper passage.
